(19) United States
(12) Patent Application Publication
(10) Pub. No.: US 2022/0027727 A1
(43) Pub. Date: Jan. 27, 2022

(54) ONLINE TRAINING OF NEURAL NETWORKS

(71) Applicant: International Business Machines Corporation, Armonk, NY (US)

(72) Inventors: Thomas Bohnstingl, Thalwil (CH); Stanislaw Andrzej Wozniak, Kilchberg (CH); Angeliki Pantazi, Thalwil (CH); Evangelos Stavros Eleftheriou, Rueschlikon (CH)

(21) Appl. No.: 17/339,978

(22) Filed: Jun. 5, 2021

Related U.S. Application Data
(60) Provisional application No. 63/054,247, filed on Jul. 21, 2020.

(51) Int. Cl. G06N 3/08; G06N 3/04

(52) U.S. Cl. CPC G06N 3/08; G06N 3/0445

(57) ABSTRACT

The invention is notably directed to a computer-implemented method for training parameters of a recurrent neural network. The network comprises one or more layers of neuronal units. Each neuronal unit has an internal state, which may also be denoted as unit state. The method comprises providing training data comprising an input signal and an expected output signal to the recurrent neural network. The method further comprises computing, for each neuronal unit, a spatial gradient component and computing, for each neuronal unit, a temporal gradient component. The method further comprises updating the temporal and the spatial gradient component for each neuronal unit at each time instance of the input signal. The computing of the spatial and the gradient component may be performed independently from each other. The invention further concerns a neural network and a related computer program product.

### CROSS-REFERENCE TO RELATED APPLICATIONS

The present application is a non-provisional of U.S. Provisional Application 63/054247, “ONLINE TRAINING OF RECURRENT NEURAL NETWORKS,” which was filed 21 Jul. 2020, hereby incorporated by reference in its entirety for all purposes.

### BACKGROUND

The invention is notably directed to a computer-implemented method for training of neural networks, in particular recurrent neural networks.

The invention further concerns a related neural network and a related computer program product.

Over recent years, the number of applications utilizing artificial neural networks (ANNs) has grown rapidly. Especially in tasks such as speech recognition, language translation or building neural computers, recurrently connected ANNs, so-called RNNs, have demonstrated astounding performance levels.

Recurrent neural networks (RNNs) have played an important role in advances of artificial intelligence in recent years. One known approach for training RNNs is gradient-based training utilizing backpropagation of errors through time (BPTT).

BPTT has however limitations, as it needs to keep track of all past activities by unrolling the network in time, which can become very deep with increasing input sequence length. For example, a two-second-long spoken input sequence with 1 ms time steps will result in a 2000-layer-deep unrolled network.

Accordingly, propagating errors backwards in time may lead to system-locking problems, rendering BPTT rather unusable for online learning scenarios. Variants that enable online training have recently regained the attention of the research community. One known approach focuses on approximating BPTT through online algorithms. Another approach takes inspiration from biology and investigates spiking neural networks (SNNs).

Accordingly, there remains a need for advantageous methods for training neural networks, in particular for online training.

### SUMMARY

According to an aspect, the invention is embodied as a computer-implemented method for training a neural network. The network comprises one or more layers of neuronal units. Each neuronal unit has an internal state, which may also be denoted as unit state. The method comprises providing training data comprising an input signal and an expected output signal to the neural network. The method further comprises computing, for each neuronal unit, a spatial gradient component and computing, for each neuronal unit, a temporal gradient component. The method further comprises updating the temporal and the spatial gradient component for each neuronal unit at each time instance of the input signal.

Accordingly, methods according to embodiments of the invention are based on a separation of spatial and temporal gradient components. This may facilitate a more profound understanding of feedback mechanisms. Furthermore, it may facilitate an efficient implementation on hardware accelerators such as memristive arrays. Methods according to embodiments of the invention may be in particular used for online training. Methods according to embodiments of the invention may be in particular used to train training parameters of the neural network.

Methods according to embodiments of the invention process as input signals temporal data. Temporal data may be defined as data that represents a state or a value in time or in other words as data relating to time instances. The input signals may be in particular continuous input data streams. The input signal is processed by the neural network at time instances or in other words time steps.

According to an embodiment, the computing of the spatial and the temporal gradient component is performed independently from each other. This has the advantage that these gradient components may be computed in parallel which reduces the computational time.

According to embodiments the spatial gradient components establish learning signals and the temporal gradient components eligibility traces.

Methods according to embodiments of the invention may be in particular used for low complexity devices such as Internet of Things (IoT) devices as well as edge Artificial Intelligence (AI)-devices.

According to embodiments, the method comprises updating training parameters of the neural network at specific or predefined time instances, in particular at each time instance. The updating may be performed in particular as a function of the spatial and the temporal gradient components.

The training parameters that may be trained according to embodiments encompass in particular input weights and/or recursive weights of the neuronal units. By updating the training parameters at each time instance, the neuronal units learn at each time instance or in other words at each time step.

According to embodiments, the spatial gradient components are based on connectivity parameters of the neural network, for example the connectivity of the individual neuronal units. According to embodiments, the connectivity parameters describe in particular parameters of the architecture of the neural network. According to embodiments, the connectivity parameters may be defined as number or the set of transmission lines that allow for information exchange between individual neuronal units. According to embodiments, the spatial gradient components are components which take into consideration the spatial aspects of the neural network, in particular interdependencies between the individual neuronal units at each time instance.

According to embodiments the temporal gradient components are based on the temporal dynamics of the neuronal units. According to embodiments, temporal gradient components are components which take into consideration the temporal dynamics of the neuronal units, in particular the temporal evolution of the internal states/unit states.

According to embodiments, the method comprises computing, at each time instance, a spatial gradient component for each of the one or more layers and computing, at each time instance, for each of the one or more layers, a temporal gradient component. Hence at each time instance/time step the method computes a temporal gradient component and a spatial gradient component per layer. The spatial gradient components/the learning signal may be specific for each layer and propagates from the last layer to the input layer without going back in time, i.e. it represents the spatial gradient passing through the network architecture.

According to embodiments, each layer may compute its own temporal gradient component/eligibility trace, which is solely dependent on contributions of the respective layer, i.e. it represents the temporal gradient passing through time for the same layer. According to embodiments, the spatial gradient components may be shared for two or more layers.

According to embodiments, the method may be used for single layer as well as multi-layer networks.

According to embodiments, the method may be applied to recurrent neural networks, spiking neural networks and hybrid networks, comprising or consisting of units that have a unit state and units that do not have a unit state

According to embodiments, the method or parts of the method may be implemented on neuromorphic hardware, in particular on arrays of memristive devices.

For shallows networks, methods according to embodiments of the invention may maintain equivalent gradients as the backpropagation through time (BPTT) technique

According to an embodiment of another aspect of the invention a neural network, in particular a recurrent neural network is provided. The neural network comprises one or more layers of neuronal units. Each neuronal unit has an internal state, which may also be denoted as unit state. The neural network is configured to perform a method comprising providing training data comprising an input signal and an expected output signal to the neural network. The method further comprises computing, for each neuronal unit, a spatial gradient component and computing, for each neuronal unit, a temporal gradient component. The method further comprises updating the temporal and the spatial gradient component for each neuronal unit at each time instance of the input signal. The computing of the spatial and the gradient component may be performed independently from each other.

According to embodiments, the neural network may be a recurrent neural network, a spiking neural network or a hybrid neural network.

According to an embodiment of another aspect of the invention, a computer program product for training a neural network is provided. The computer program product comprises a computer readable storage medium having program instructions embodied therewith, the program instructions executable by the neural network to cause the neural network to perform a method comprising steps of receiving training data comprising an input signal and an expected output signal. The method comprises further steps of computing, for each neuronal unit, a spatial gradient component and computing, for each neuronal unit, a temporal gradient component, Further steps include updating the temporal and the spatial gradient component for each neuronal unit at each time instance of the input signal. According to embodiments the computing of the spatial and the temporal gradient component may be performed independently from each other.

Embodiments of the invention will be described in more detail below, by way of illustrative and non-limiting examples, with reference to the accompanying drawings.

### BRIEF DESCRIPTION OF THE DRAWINGS

FIG. 1 illustrates the gradient flow of a computer-implemented method for training a neural network according to an embodiment of the invention;

FIG. 2 illustrates the gradient flow of a computer-implemented method for training a neural network according to an embodiment of the invention;

FIG. 3 shows a spiking neuronal unit of a spiking neural network;

FIG. 4a shows test results of methods according to embodiments of the invention compared with back propagation through time (BPPT) techniques;

FIG. 4b shows further test results of methods according to embodiments of the invention compared with back propagation through time (BPPT) techniques;

FIG. 5 shows test result of another task concerning handwritten digit classification;

FIG. 6 illustrates how methods according to embodiments of the invention can be implemented on neuromorphic hardware;

FIG. 7 shows a simplified schematic diagram of a neural network according to an embodiment of the invention;

FIG. 8 shows a flow chart of method steps of a computer-implemented method for training parameters of a recurrent neural network;

FIG. 9 shows an exemplary embodiment of a computing system for performing a method according to embodiments of the invention;

FIG. 10 and FIG. 11 show exemplary detailed derivation of methods according to embodiments of the invention for deep neural networks.

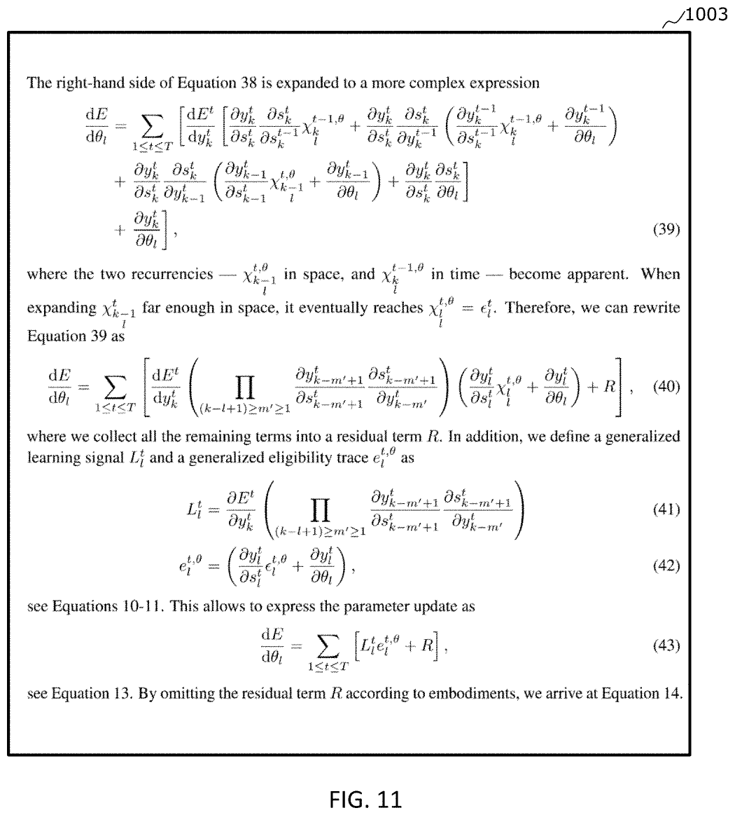

### DETAILED DESCRIPTION

Embodiments of the invention provide a method for training, in particular online training of neural networks, in particular recurrent neural networks (RNNs). The method may be in the following also denoted as OSTL. Methods according to embodiments of the invention provide an advantageous algorithm which can be used for online learning applications by separating spatial and temporal gradients.

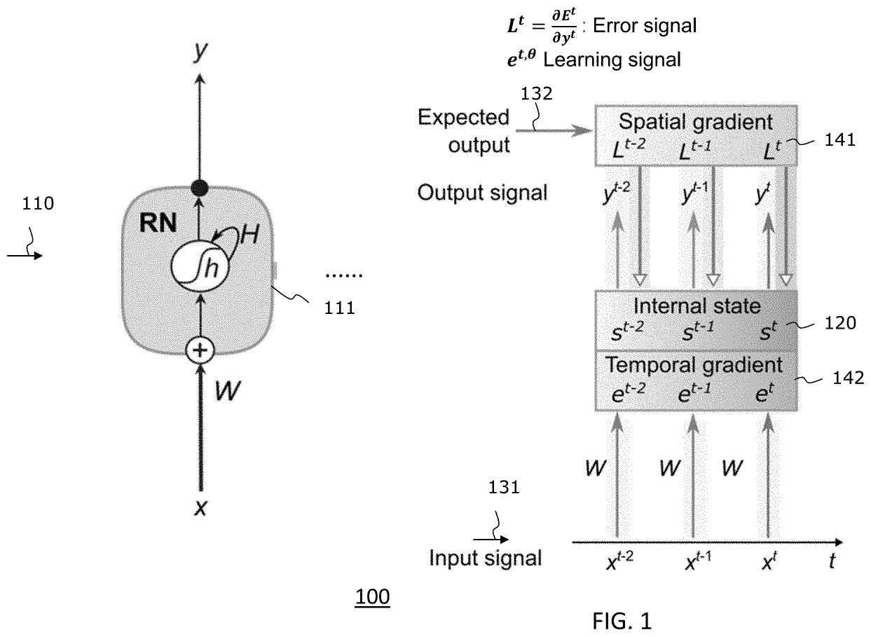

FIG. 1 illustrates the gradient flow of a computer-implemented method for training a neural network 100 according to an embodiment of the invention. For FIG. 1 it is assumed that the neural network 100 is a recurrent neural network (RNN) with a single layer 110 comprising neuronal units 111. The neural network is unfolded for three time steps t.

Each neuronal unit 111 has an internal state S, 120. The method comprises providing training data comprising an input signal x^{t}, 131 and an expected output signal 132 to the neural network. Then, the method computes for each neuronal unit 110 a spatial gradient component L^{t}, 141 and a temporal gradient component e^{t}, 142. Furthermore, at each time instance t of the input signal 131, the temporal gradient components 130 and the spatial gradient components 131 are updated for each neuronal unit 110.

The objective of the learning/training is to train parameters θ of the neural network such that it minimizes the error E^{t} between the current output signal y^{t} at a time t and the input signal x^{t}.

In RNNs, the network error E^{t} at time t is often a function of the output y^{t} of the neuronal units in the output layer, i.e. E^{t}=f(y^{t}). In addition, many neuronal units in RNNs may contain an internal state s^{t} on which the output depends, i.e. y^{t}=f(s^{t}). This internal state of the neuronal units may be a recursive function of itself that in addition depends on its inputs signal x^{t} and recursively on its output signals through trainable input weights W and trainable recurrent weights H, respectively.

According to embodiments, an equation governing the internal state can be formulated as s^{t}=f(x^{t}, s^{t-1}, y^{t-1}, W, H), for example s^{t}=W x^{t}+H y^{t-1}.

For the sake of notational simplicity, all the trainable parameters of the RNN 100 may be in the following collectively described by a variable θ. This simplifies the above equation to s^{t}=f(x^{t}, s^{t-1}, y^{t-1}, θ).

Moreover, the notation of the output y^{t} may be extended according to embodiments to also allow for a direct dependency on the trainable parameters, i.e. y^{t}=f(s^{t}, θ), for example y^{t}=σ(s^{t}+b).

Using this notation, the required change of the parameters θ to minimize E may be computed based on the principle of gradient descent as

$$Δθ = - η \frac{dE}{d θ} . \qquad ( 1 )$$

From this, embodiments of the invention use the backpropagation through time (BPTT) technique as a starting point for the derivation and express dE/dθ as

$$\frac{dE}{D θ} = {\sum }_{1 \leq t \leq T} \frac{\partial {E}^{t}}{\partial {y}^{t}} [ \frac{\partial {y}^{t}}{\partial {s}^{t}} \frac{{ds}^{t}}{d θ} + \frac{\partial {y}^{t}}{\partial θ} ] , \qquad ( 2 )$$

where the summation over time ranges from the first time step t=1 until the last time step t=T. Then Equation 2 is expanded below and a recursion is unraveled that can be exploited to form an online reformulation of BPTT. For the sake of brevity, we outline only the main steps for a single unit, but the detailed derivation is given in the supplementary material. further below. In particular, it can be shown that

$$\frac{{ds}^{t}}{d θ} = {\sum }_{1 \leq \hat{t} \leq t} ( {\prod }_{t \geq {t}^{′} > \hat{t}} \frac{{ds}^{{t}^{′}}}{{ds}^{{t}^{′} - 1}} ) ( \frac{\partial {s}^{\hat{t}}}{\partial θ} + \frac{\partial {s}^{\hat{t}}}{\partial {y}^{\hat{t} - 1}} \frac{\partial {y}^{\hat{t} - 1}}{\partial θ} ) . \qquad ( 3 )$$

Equation 3 can be rewritten in a recursive form as follows

$${∈}^{t , θ} \text{:=} \frac{{ds}^{t}}{d θ} = ( \frac{{ds}^{t}}{{ds}^{t - 1}} {∈}^{t - 1 , θ} + ( \frac{\partial {s}^{t}}{\partial θ} + \frac{\partial {s}^{t}}{\partial {y}^{t - 1}} \frac{\partial {y}^{t - 1}}{\partial θ} ) ) . \qquad ( 4 )$$

This leads to an expression of the gradient as

$$\begin{matrix}\frac{dE}{d θ} = {\sum }_{t} {L}^{t} {e}^{t , θ} , & ( 5 ) \\ where & \\ {e}^{t , θ} \text{:=} \frac{{dy}^{t}}{d θ} = \frac{\partial {y}^{t}}{\partial {s}^{t}} {∈}^{t , θ} + \frac{\partial {y}^{t}}{\partial θ} & ( 6 ) \\ {L}^{t} \text{:=} \frac{\partial {E}^{t}}{\partial {y}^{t}} . & ( 7 )\end{matrix}$$

Hence according to embodiments, the computing of the spatial and the gradient component may be performed independently from each other.

In the example of standard RNNs, the explicit form of these equations is

$$\begin{matrix}\frac{{ds}_{l}^{t}}{{ds}_{l}^{t - 1}} = {H}_{l} {h}_{l}^{′ t - 1} \\ {∈}^{t , W} = \frac{{ds}^{t}}{{ds}^{t - 1}} {∈}^{t - 1 , W} + {x}^{t} {e}^{t , W} = {σ}^{′ t} {∈}^{t , W} \\ {∈}^{t , H} = \frac{{ds}^{t}}{{ds}^{t - 1}} {∈}^{t - 1 , H} + {y}^{t - 1} {e}^{t , H} = {σ}^{′ t} {∈}^{t , H} \\ {∈}^{t , b} = \frac{{ds}^{t}}{{ds}^{t - 1}} {∈}^{t - 1 , b} + H {σ}^{′ t - 1} {e}^{t , b} = {σ}^{′ t} {∈}^{t , b} + {σ}^{′ t}\end{matrix}$$

According to embodiments the notation takes inspiration from the standard nomenclature of biological systems, where the change of synaptic weights is often decomposed into a learning signal and an eligibility trace. In the simplest case, eligibility traces are low-pass filtered versions of the neural activities, while learning signals represent spatially delivered reward signals.

Therefore, according to embodiments the temporal gradients denoted e^{t,θ} in Equation 6 may be associated with eligibility traces and the spatial gradients denoted as L^{t} in Equation 7 may be associated with learning signals.

Similar to biological systems, the parameter change dE/dθ according to Equation 5 is calculated as the sum over time of products of the eligibility trace and the learning signal. This enables the parameter updates to be computed online, as shown in FIG. 1.

Furthermore, it should be noted that the derivation in equation 6 is exact.

As can be seen in FIG. 1, at each time step the temporal gradients may be combined with the spatial gradients of this time step and do not need to go back until the beginning of the input sequence/input signal as required according to the known backpropagation though time technique.

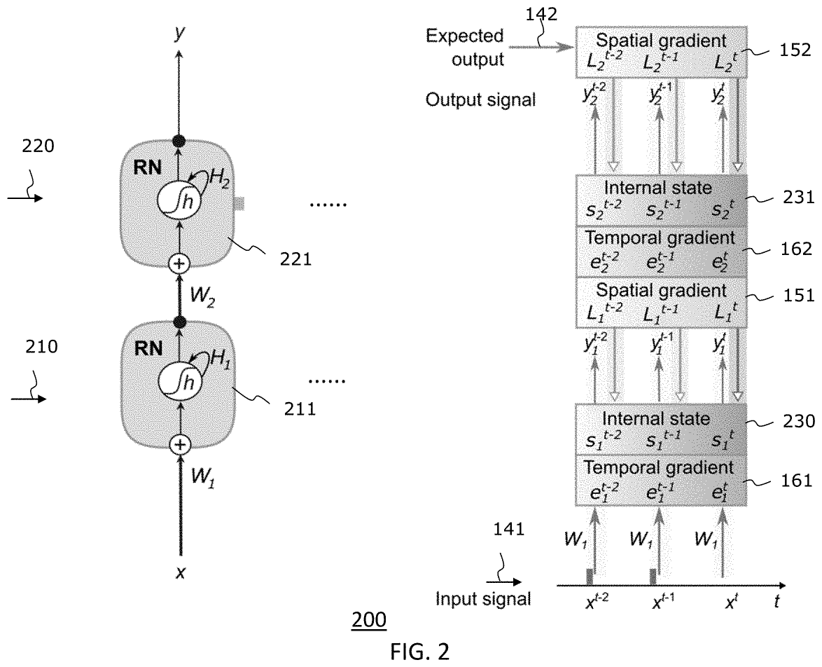

FIG. 2 illustrates the gradient flow of a computer-implemented method for training a neural network 200 according to an embodiment of the invention. For FIG. 2 it is assumed that the neural network 200 is a recurrent neural network (RNN) with multiple layers.

More particularly, FIG. 2 illustrates the gradient flow for a two-layer RNN comprising first layer 210 with neuronal units 211 and a second layer 220 with neuronal units 221. The layers 210 and 220 are unfolded for three time steps and the spatial and temporal gradients are separated.

Each neuronal unit 211 has an internal state S₁, 230. Each neuronal unit 221 has an internal state S₂, 231. The method comprises providing training data comprising an input signal x^{t}, 141 and an expected output signal 142 to the neural network 200. Then, the method computes for each neuronal unit 211 a spatial gradient component L₁^{t}, 151 and for each neuronal unit 221 a spatial gradient component L₂^{t}, 152. Furthermore, the method computes for each neuronal unit 211 a temporal gradient component e₁^{t}, 161 and for each neuronal unit 221 a temporal gradient component e₂^{t}, 162.

Furthermore, at each time instance t of the input signal 141, the temporal gradient components 161, 162 and the spatial gradient components 151, 152 are updated for each neuronal unit 211, 221 respectively.

Many state-of-the-art applications rely on more complicated multi-layer architectures. To extend methods according to embodiments of the invention to deep architectures, the definitions of the state s^{t} and the output y^{t} may be revisited as follows. The error E^{t} in deep architectures is only a function of the last output layer k, i.e. E^{t}=f(yk^{t}) and each layer l has its own trainable parameters θ₁. The input to layer l is the output of the previous layer y₁₋ₗ^{t} and for the first layer, the external input is used y₀^{t}=x^{t}.

Thus, the definitions may be adapted to

$$\begin{matrix}{s}_{l}^{t} = f ( {s}_{l}^{t - 1} , {y}_{l}^{t - 1} , {y}_{l - 1}^{t} , {θ}_{l} ) & ( 8 ) \\ {y}_{l}^{t} = f ( {s}_{l}^{t} , {θ}_{l} ) . , & ( 9 )\end{matrix}$$

For a single-layer neural network, the separation of spatial and temporal components comes if one follows the derivations outlined by Equations 3 to 5.

However, for a multi-layer architecture, the term ds^{t}/dθ in Equation 3 may involve different layers l and m, e.g. dₛₗ^{t}/dθₘ, and thereby introduces dependencies across layers, see supplementary material.

In order to maintain the benefits discussed above, the clear separation of spatial and temporal gradients is also introduced for multi-layer architectures according to embodiments of the invention. Accordingly, similar steps as described above for a single layer RNN are performed using the generalized state and output Equations 8 and 9. Following the detailed derivations in the supplementary material, the following eligibility traces and learning signals are obtained for layer l:

$$\begin{matrix}{e}_{l}^{t , θ} = ( \frac{\partial {y}_{l}^{t}}{\partial {s}_{l}^{t}} {∈}_{l}^{t , θ} + \frac{\partial {y}_{l}^{t}}{\partial {θ}_{l}} ) & ( 10 ) \\ {L}_{l}^{t} = \frac{\partial {E}^{t}}{\partial {y}_{k}^{t}} ( {\prod }_{( k - l + 1 ) \geq {m}^{′} \geq 1} \frac{\partial {y}_{k - {m}^{′} + 1}^{t}}{\partial {s}_{k - {m}^{′} + 1}^{t}} \frac{\partial {s}_{k - {m}^{′} + 1}^{t}}{\partial {y}_{k - {m}^{′}}^{t}} ) , & ( 11 ) \\ where & \\ {∈}_{l}^{t , θ} = ( \frac{{ds}_{l}^{t}}{{ds}_{l}^{t - 1}} {∈}_{l}^{t - 1 , θ} + ( \frac{\partial {s}_{l}^{t}}{\partial {θ}_{l}} + \frac{\partial {s}_{l}^{t}}{\partial {y}_{l}^{t - 1}} \frac{\partial {y}_{l}^{t - 1}}{\partial {θ}_{l}} ) ) . & ( 12 )\end{matrix}$$

Then, it can be shown that

$$\frac{dE}{d {θ}_{l}} = {\sum }_{t} [ {L}_{l}^{t} {e}_{l}^{t , θ} + R ] . \qquad ( 13 )$$

As one can see by comparing equations 5 to 13, the approach according to embodiments of the invention concerning multiplying a learning signal Lₗ^{t} with an eligibility trace eₗ^{t,θ} stays the same in case of deep networks.

The learning signal Lₗ^{t} is specific for each layer and propagates from the last layer to the input layer without going back in time, i.e. it represents the spatial gradient passing through the network architecture. Furthermore, each layer computes its own eligibility trace eₗ^{t,θ}, which is solely dependent on contributions of the respective layer l, .e. it represents the temporal gradient passing through time for the same layer.

However, additional terms are also involved in Equation 13, which either contain a mix of spatial and temporal gradients and generally require to go back in time. These terms are collected in the residual term R.

In order to maintain the separation between spatial and temporal gradients, Equation 13 is simplified according to embodiments by omitting the term R. Thus, the following formulation for multi-layer networks is obtained according to embodiments:

$$\frac{dE}{d {θ}_{l}} = {\sum }_{t} {L}_{l}^{t} {e}_{l}^{t , θ} . \qquad ( 14 )$$

Hence according to embodiments of the invention the residual term R is consciously omitted, and the mixed spatial and temporal gradient components are not taken into consideration during learning/training. However, investigations of the inventors of the present invention have resulted in the insight that this is an advantageous approach. In particular, with such an approach it is known what is omitted. Furthermore, simulations of the inventors have provided empirical evidence that a competitive performance to BPTT may be achieved even without these terms, as will be explained further below.

Moreover, according to embodiments the residual term R may also be approximated, hence allowing to even better approximate the gradients from Equation 13.

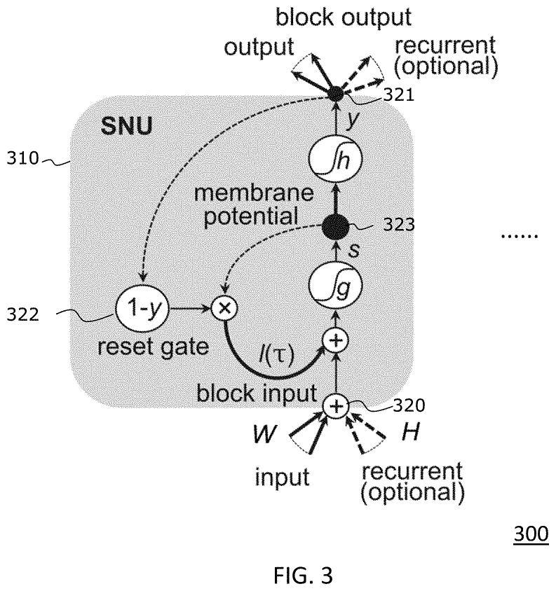

FIG. 3 shows a spiking neuronal unit SNU, 310 of a spiking neural network 300. With reference to FIG. 3 it will be shown that methods according to embodiment can be applied to spiking neural networks (SNN). Dashed lines in FIG. 3 indicate connections with time-lag, while bold lines indicate parametrized connections. The SNU 310 comprises a block input 320, a block output 321, a reset gate 322 and a membrane potential 323.

While historically, SNNs were often trained with variants of spike timing-dependent plasticity, recently gradient-based training for SNNs has been proposed, e.g. in the document: Wozniak, S., Pantazi, A., Bohnstingl, T., and Eleftheriou, E. Deep learning incorporating biologically-inspired neural dynamics. arXiv, Dec 2018. URL https://arxiv. org/abs/1812.07040.

Such a method aims to bridge the ANN world with the SNN world by recasting the SNN dynamics with ANN-based building blocks, forming the spiking neuronal unit SNU, 310. The SNUB 310 of the spiking neural network 300 receive a plurality of input signals

With this approach, SNUB enable gradient-based learning, This allows to exploit the power of known optimization techniques for ANN, while still reproducing the dynamics of the leaky integrate-and-fire (LIF) neuron model, which is well-known in neuroscience.

As shown above methods according to embodiments of the invention may be used for generic RNNs, but can also be applied according to embodiments to train deep SNNs formulated as RNNs. This will be shown in the following. We start from the state and output equations of an SNU layer 1, compare (Wozniak et al., 2018):

$$\begin{matrix}{s}_{l}^{t} = g ( {W}_{l} {y}_{l - 1}^{t} + {H}_{l} {y}_{l}^{t - 1} + l ( τ ) {s}_{l}^{t - 1} ( 1 - {y}_{l}^{t - 1} ) ) & ( 15 ) \\ {y}_{l}^{t} = h ( {s}_{l}^{t} + {b}_{l} ) . & ( 16 )\end{matrix}$$

By using Equations 15 and 16, we derive the eligibility traces according to Equation 10, as

$$\begin{matrix}{e}_{l}^{t , W} = {h}_{l}^{′ t} {ϵ}_{l}^{t , W} & ( 17 ) \\ {e}_{l}^{t , H} = {h}_{l}^{′ t} {ϵ}_{l}^{t , H} & ( 18 ) \\ {e}_{l}^{t , b} = {h}_{l}^{′ t} {ϵ}_{l}^{t , b} + {h}_{l}^{′ t} , where & ( 19 ) \\ {ϵ}_{l}^{t , W} = {g}_{l}^{′ t} \cdot [ \frac{d {s}_{l}^{t}}{{ds}_{l}^{t - 1}} {ϵ}_{l}^{t - 1 , W} + {y}_{l - 1}^{t} ] \\ {ϵ}_{l}^{t , H} = {g}_{l}^{′ t} \cdot [ \frac{d {s}_{l}^{t}}{{ds}_{l}^{t - 1}} {ϵ}_{l}^{t - 1 , H} + {y}_{l - 1}^{t} ] \\ {ϵ}_{l}^{t , b} = {g}_{l}^{′ t} \cdot [ \frac{d {s}_{l}^{t}}{{ds}_{l}^{t - 1}} {ϵ}_{l}^{t - 1 , b} + l ( τ ) {s}_{l}^{t - 1} {h}_{l}^{′ t - 1} + {H}_{l} {h}_{l}^{′ t - 1} ] \\ and \\ \frac{{ds}_{l}^{t}}{{ds}_{l}^{t - 1}} = l ( τ ) ( 1 - {y}_{l}^{t - 1} - {s}_{l}^{t - 1} {h}_{l}^{′ t - 1} ) + {H}_{l} {h}_{l}^{′ t - 1} . & ( 20 )\end{matrix}$$

It should be noted that the short-hand notation of

$$\frac{d g ( {χ}_{l}^{t} )}{d {χ}_{l}^{t}} = {g}_{l}^{′ t} and \frac{d h ( {χ}_{l}^{t} )}{d {χ}_{l}^{t}} = {h}_{l}^{′ t} .$$

has been used.

For a mean squared error loss function, e.g.

$${E}^{t} = {( {\hat{y}}^{t} - {y}_{k}^{t} )}^{2} , where {\hat{y}}^{t}$$

is the target output, the learning signal can be calculated as:

$$\begin{matrix}{L}_{l}^{t} = - 2 ( {\hat{y}}^{t} - {y}_{k}^{t} ) & ( 21 ) \\ [ {\prod }_{( k - l + 1 ) \geq {m}^{′} \geq 1} {h}_{k - {m}^{′} + 1}^{′ t} {g}_{k - {m}^{′} + 1}^{′ t} {W}_{k - {m}^{′} + 1}^{′ t} ] . & ( 22 )\end{matrix}$$

For a deep neural network with k layers consisting of RNNs or recurrent SNUB, methods according to embodiments of the invention have time complexity of O(kn4). This time complexity is determined by the network structure itself and is primarily dominated by the recurrency matrix H₁. If feed-forward architectures are used according to embodiments, the terms involving H₁ vanish, and the equations of SNU become

$$\begin{matrix}{s}_{l}^{t} = g ( {W}_{l} {y}_{l - 1}^{t} + l ( τ ) {s}_{l}^{t - 1} ( 1 - {y}_{l}^{t - 1} ) ) & ( 23 ) \\ {y}_{l}^{t} = h ( {s}_{l}^{t} + {b}_{l} ) . & ( 24 )\end{matrix}$$

These equations then lead to the following eligibility traces

$$\begin{matrix}{e}_{l}^{t , W} = {h}_{l}^{′ t} {ϵ}_{l}^{t , W} & ( 25 ) \\ {e}_{l}^{t , b} = {h}_{l}^{′ t} {ϵ}_{l}^{t , b} + {h}_{l}^{′ t} , \\ where & ( 26 ) \\ {ϵ}_{l}^{t , W} = {g}_{l}^{′ t} \cdot [ \frac{d {s}_{l}^{t}}{{ds}_{l}^{t - 1}} {ϵ}_{l}^{t - 1 , W} + {y}_{l - 1}^{t} ] \\ {ϵ}_{l}^{t , b} = {g}_{l}^{′ t} \cdot [ \frac{d {s}_{l}^{t}}{{ds}_{l}^{t - 1}} {ϵ}_{l}^{t - 1 , b} + l ( τ ) {s}_{l}^{t - 1} {h}_{l}^{′ t - 1} ] , \\ with . & \\ \frac{{ds}_{l}^{t}}{{ds}_{l}^{t - 1}} = l ( τ ) ( 1 - {y}_{l}^{t - 1} - {s}_{l}^{t - 1} {h}_{l}^{′ t - 1} ) . & ( 27 )\end{matrix}$$

This greatly reduces the time complexity from O(kn⁴) to O(kn²). Using feed-forward SNU network architecture does not necessarily prevent solving temporal tasks. Such networks have long been used in SNNs and it implies that the network should rely on the internal states of the units, implemented using self-recurrency, rather than on layer-wise recurrency matrices

Hi.

It should be noted that according to embodiments, the learning signal may be computed without the matrices W, e.g. based on some randomization or approximations of W. More particularly, the learning signal may be computed based on different matrices that are not used in the forward path. In other words, the forward path may use matrices W, while the learning signal is computed on different matrices B. The matrices B might be trainable or not.

According to embodiments, methods as presented above may also be used for hybrid networks. In this respect, a very common scenario in deep RNNs or SNNs is that they are often coupled with layers of stateless neurons at the output, for example sigmoid or softmax layers. Methods according to embodiments of the invention can also be applied without any modifications to train these hybrid networks containing one or more layers of stateless neurons. In particular, the state and output equations of these layers simplify to

$$\frac{{ds}_{l}^{t}}{{ds}_{l}^{t - 1}}$$

which causes the term

$${s}_{l}^{t} = f ( {y}_{l - 1}^{t} , {θ}_{l} ) and {y}_{l}^{t} = f ( {s}_{l}^{t} , {θ}_{l} ) ,$$

in Equation 12 to vanish and the eligibility traces and learning signals can be calculated as

$$\begin{matrix}{e}_{l}^{t , θ} = \frac{\partial {y}_{l}^{t}}{\partial {s}_{l}^{t}} {ϵ}_{l}^{t , θ} + \frac{\partial {y}_{l}^{t}}{\partial {θ}_{l}} & ( 28 ) \\ {L}_{l}^{t} = \frac{\partial {E}^{t}}{\partial {y}_{l}^{t}} ( {\prod }_{( k - l + 1 ) \geq {m}^{′} \geq 1} \frac{\partial {y}_{k - {m}^{′} + 1}^{t}}{\partial {s}_{k - {m}^{′} + 1}^{t}} \frac{\partial {s}_{k - {m}^{′} + 1}^{t}}{\partial {y}_{k - {m}^{′}}^{t}} ) , \\ with & ( 29 ) \\ {ϵ}_{l}^{t , θ} = \frac{\partial {s}_{l}^{t}}{\partial {θ}_{l}} . & ( 30 )\end{matrix}$$

It should be noted that a stateless layer will not introduce any residual terms R. This has the effect that when adding such a layer to the network, even between RNN layers, the gradients for the subsequent layers remain unchanged.

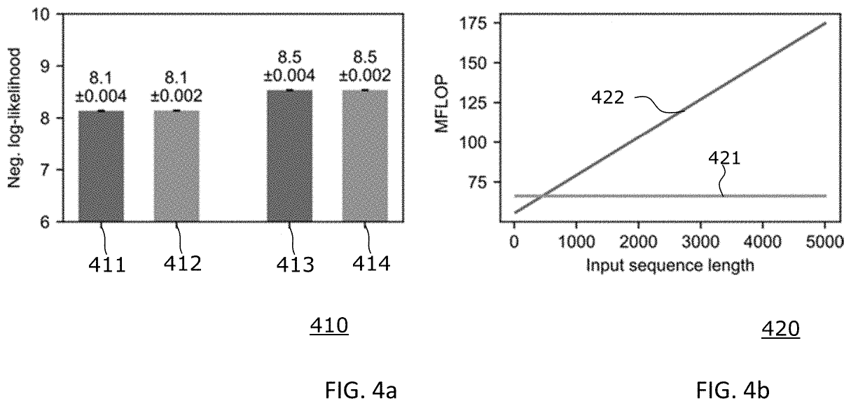

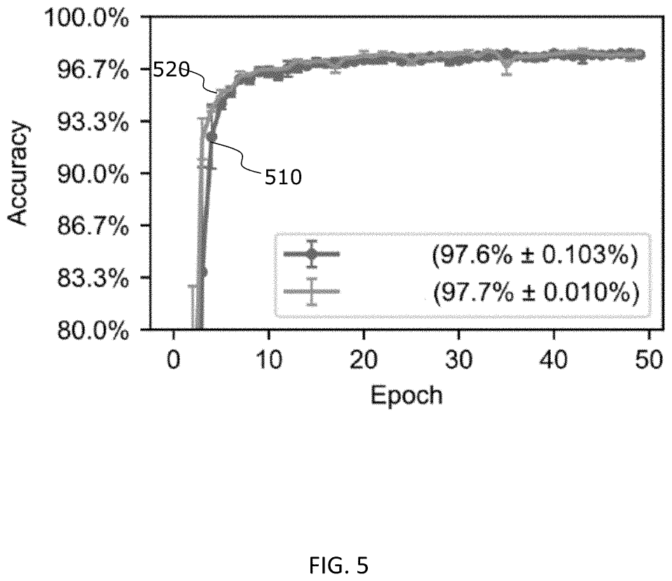

FIG. 4a shows test results of methods according to embodiments of the invention compared with back propagation though time (BPPT) techniques. More particularly, FIG. 4a concerns music prediction based on the JSB dataset as introduced in the document: Boulanger-Lewandowski, N., Bengio, Y., and Vincent, P. Modeling temporal dependencies in high-dimensional sequences: Application to polyphonic music generation and transcription In Proceedings of the 29th International Conference on International Conference on Machine

Learning, ICML'12, pp. 1881-1888, Madison, Wis., USA, 2012. Omnipress. ISBN 9781450312851. For this the standard training/testing data split was used. For the test a hybrid architecture comprising a feed-forward SNU layer with 150 units and a stateless layer sigmoid layer with 88 units on top. To obtain a baseline, the same network, including all its hyperparameters, was trained with methods according to embodiments of the invention and BPTT for 1000 epochs. The Y-axis denotes the negative log-likelihood, averaged over 10 random initial conditions. The bar 411 shows the result for the training of the BPTT method, while bar 412 shows the result for the training of methods according to embodiments of the invention. Furthermore, the bar 413 shows the result for the test run of the BPTT method, while bar 414 shows the result for the test run of methods according to embodiments of the invention.

As shown in FIG. 4a, the results obtained with methods according to embodiments of the invention are practically on par with these obtained with BPTT. Note that task proves the gradient equivalence of BPTT and of methods according to embodiments of the invention for a hybrid architecture with a single RNN layer and a stateless layer on top.

As shown in FIG. 4b, this task may be used to demonstrate the reduced computational complexity of methods according to embodiments of the invention for feed-forward SNNs. To this end, the number of required floating point operations MFLOP (y-axis) was measured, using the built-in TensorFlow profiler, for one parameter updated across different input sequence lengths (x-axis) of the JSB input sequence, see FIG. 4b. As can be seen from line 421, BPTT needs to perform temporal unrolling, hence the linear dependence on the length of the sequence T, whereas methods according to embodiments of the invention as shown by line 422 do not and hence it remains steady. However, in practical implementations one may need to accumulate the updates from methods according to embodiments of the invention over time, which results in the same complexity as BPTT. Note that the initially higher cost of methods according to embodiments of the invention is due to implementation overheads, as methods according to embodiments of the invention are not contained in the standard toolbox of TensorFlow. Nevertheless, the obtained plot is consistent with theoretical complexity analysis.

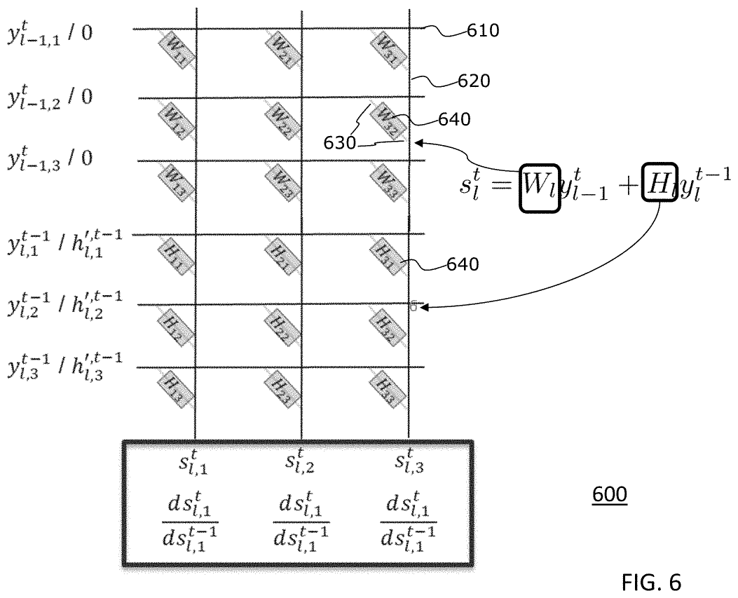

FIG. 5 shows test result of another task concerning handwritten digit classification based on the MNIST dataset as introduced in the document: Lecun, Y., Bottou, L., Bengio, Y., and Haffner, P. Gradient based learning applied to document recognition. Proc. IEEE, 86(11): 2278-2324, Nov 1998. ISSN 1558-2256. doi: 10.1109/5.726791.

Again the standard training/testing data split was used. According to the test a feed-forward architecture of five layers of SNUs with 256 units was employed and trained for 50 epochs averaging over 10 random initial conditions. Similar to the task illustrated with reference to FIGS. 4a and 4b, the accuracy of methods according to embodiments of the invention matches the one of BPTT. The y-axis denotes the accuracy (percentage), the x-axis the number of epochs, the line 510 the results for BPTT and the line 520 the results for methods according to embodiments of the invention.

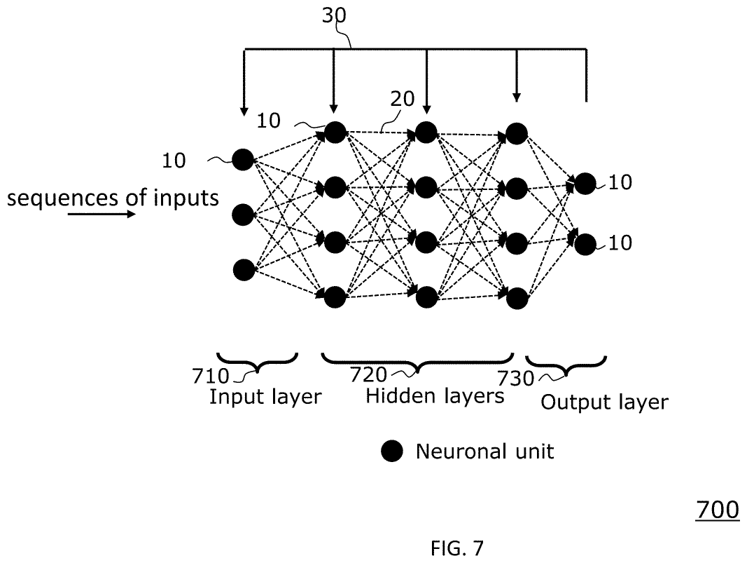

FIG. 6 illustrates how methods according to embodiments of the invention can be implemented on neuromorphic hardware. The neuromorphic hardware may comprise in particular a crossbar array comprising a plurality of row lines 610, a plurality of column lines 620 and a plurality of junctions 630 arranged between the plurality of row lines 610 and the plurality of column lines 620. Each junction 630 comprises a resistive memory element 640, in particular a serial arrangement of a resistive memory element and an access element comprising an access terminal for accessing the resistive memory element. The resistive elements may be e.g. phase-change memory elements, conductive bridge random access memory elements (CBRAM), metal-oxide resistive random access memory elements (RRAM), magneto-resistive random access memory elements (MRAM), ferroelectric random access memory elements (FeRAM) or optical memory elements.

According to embodiments the input weights and the recursive weights may be placed on the neuromorphic device, in particular as resistance states of the resistive elements.

According to such an embodiment the trainable input weights W₁ and the trainable recurrent weights H₁ are mapped to the resistive memory elements 640.

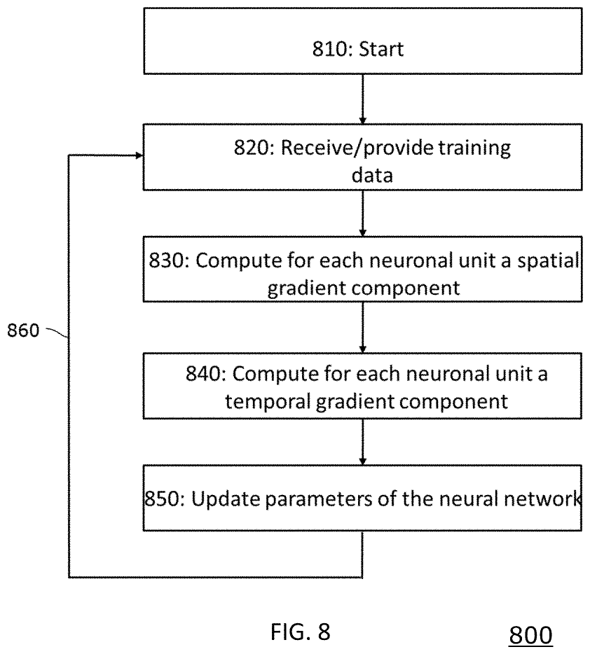

FIG. 7 shows a simplified schematic diagram of a neural network 700 according to an embodiment of the invention. The neural network 700 comprises an input layer 710 comprising a plurality of neuronal units 10, one or more hidden layers 720 comprising a plurality of neuronal units 10 and an output layer 730 comprising a plurality of neuronal units 10. The neural network 700 comprises a plurality of electrical connections 20 between the neuronal units 10. The electrical connections 20 connect the outputs of neurons from one layer, e.g. from the input layer 710, to the inputs of neuronal units from the next layer, e.g. one of the hidden layers 720. The neural network 700 may be in particular embodied as recurrent neural network.

Accordingly, the network 700 comprises recurrent connections from one layer to the neuronal units from the same or a previous layer as illustrated in a schematic way by the arrows 30.

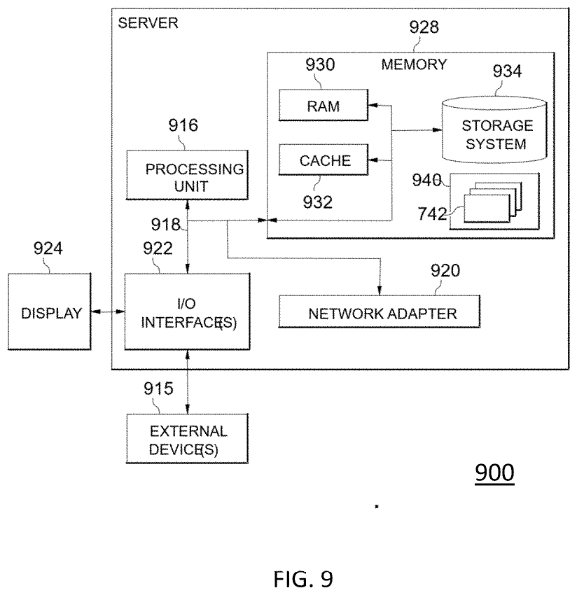

FIG. 8 shows a flow chart of method steps of a computer-implemented method for training parameters of a recurrent neural network.

The method starts at a step 810.

At a step 820, training data is received by or in other words provided to the neural network. The training data comprises an input signal and an expected output signal.

At a step 830, the neural network computes for each neuronal unit a spatial gradient component.

At a step 840, the neural network computes for each neuronal unit a temporal gradient component.

At a step 850, the neural network updates the temporal and the spatial gradient component for each neuronal unit at each time instance of the input signal.

According to an embodiment, the updates of the parameters of the neural network can be accumulated and deferred until a later time step T. The computing of the spatial and the gradient component is performed independently from each other.

The steps 820 to 850 are repeated at loops 860. More particularly, the steps 820 to 850 may be repeated at specific or predefined time instances and in particular at each time instance.

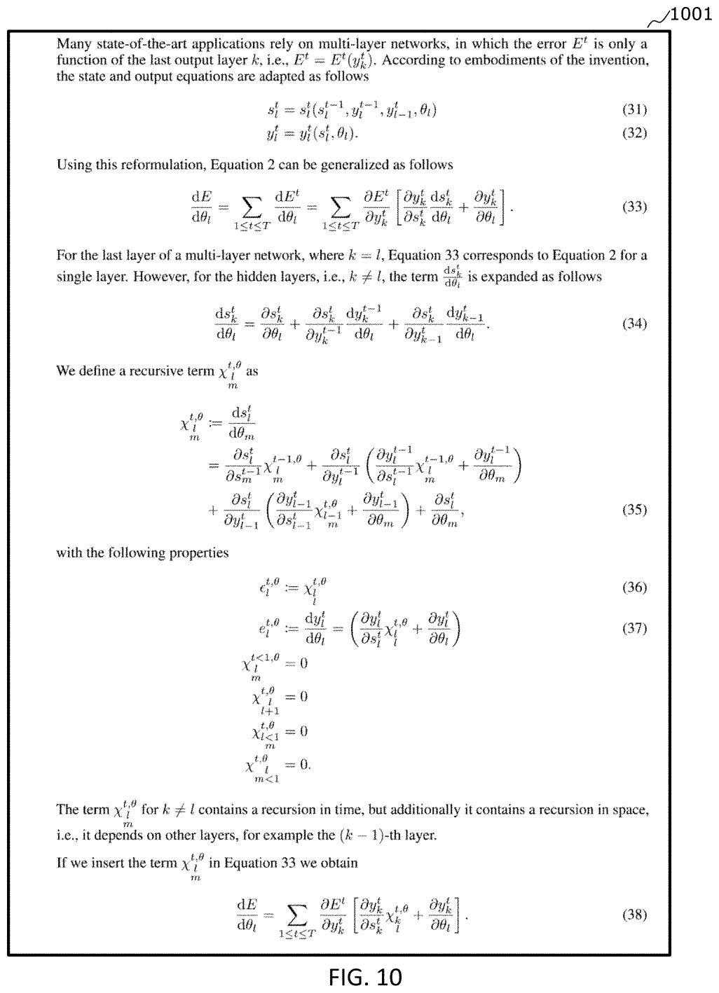

Referring now to FIG. 9, an exemplary embodiment of a computing system 900 for performing a method according to embodiments of the invention is illustrated. The computing system 900 may form a neural network according to embodiments. The computing system 900 may be operational with numerous other general purpose or special purpose computing system environments or configurations. Examples of well-known computing systems, environments, and/or configurations that may be suitable for use with computing system 900 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computing system 900 may be described in the general context of computer system-executable instructions, such as program modules, being executed by a computer system. Generally, program modules may include routines, programs, objects, components, logic, data structures, and so on that perform particular tasks or implement particular abstract data types. The computing system 900 may be shown in the form of a general-purpose computing device. The components of server computing system 900 may include, but are not limited to, one or more processors or processing units 916, a system memory 928, and a bus 918 that couples various system components including system memory 928 to processor 916.

Bus 918 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing system 900 typically includes a variety of computer system readable media. Such media may be any available media that is accessible by computing system 900, and it includes both volatile and non-volatile media, removable and non-removable media.

System memory 928 can include computer system readable media in the form of volatile memory, such as random access memory (RAM) 930 and/or cache memory 932. Computing system 900 may further include other removable/non-removable, volatile/non-volatile computer system storage media. By way of example only, storage system 934 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 918 by one or more data media interfaces. As will be further depicted and described below, memory 928 may include at least one program product having a set (e.g., at least one) of program modules that are configured to carry out the functions of embodiments of the invention.

Program/utility 940, having a set (at least one) of program modules 942, may be stored in memory 928 by way of example, and not limitation, as well as an operating system, one or more application programs, other program modules, and program data. Each of the operating system, one or more application programs, other program modules, and program data or some combination thereof, may include an implementation of a networking environment. Program modules 942 generally carry out the functions and/or methodologies of embodiments of the invention as described herein. Program modules 942 may carry out in particular one or more steps of a computer-implemented for training recurrent neural networks, e.g. one or more steps of the method as described with reference to FIGS. 1, 2 and 8.

Computing system 900 may also communicate with one or more external devices 915 such as a keyboard, a pointing device, a display 924, etc.; one or more devices that enable a user to interact with computing system 900; and/or any devices (e.g., network card, modem, etc.) that enable computing system 900 to communicate with one or more other computing devices. Such communication can occur via Input/Output (I/O) interfaces 922. Still yet, computing system 900 can communicate with one or more networks such as a local area network (LAN), a general wide area network (WAN), and/or a public network (e.g., the Internet) via network adapter 920. As depicted, network adapter 920 communicates with the other components of computing system 900 via bus 918. It should be understood that although not shown, other hardware and/or software components could be used in conjunction with computing system 900. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In general, modifications described for one embodiment may be applied to another embodiment as appropriate.

In the following a detailed derivation of methods according to embodiments of the invention for deep neural networks, in particular for recurrent networks comprising multi-layer architectures, will be provided as supplement.

Many state-of-the-art applications rely on multi-layer networks, in which the error E^{t} is only a function of the last output layer k, i.e., E^{t}=E^{t}(yₖ^{t}). According, to embodiments of the invention, the state and output equations are adapted as follows

sₗ^{t}=sₗ^{t}(sₗ^{t-1}, yₗ^{t-1}, yₗ₋₁^{t}, θₗ) (31)

yₗ^{t}=yₗ^{t}(sₗ^{t}, θₗ) (32)

Using this reformulation, Equation 2 can be generalized as follows

$$\frac{dE}{d {θ}_{l}} = {\sum }_{1 \leq t \leq T} \frac{{dE}^{t}}{d {θ}_{l}} = {\sum }_{1 \leq t \leq T} \frac{\partial {E}^{t}}{\partial {y}_{k}^{t}} [ \frac{\partial {y}_{k}^{t}}{\partial {s}_{k}^{t}} \frac{{ds}_{k}^{t}}{d {θ}_{l}} + \frac{\partial {y}_{k}^{t}}{\partial {θ}_{l}} ] . \qquad ( 33 )$$

For the last layer of a multi-layer network, where k=l, Equation 33 corresponds to Equation 2 for a single layer. However, for the hidden layers, i.e., k≠l, the term

$$\frac{{ds}_{k}^{t}}{d {θ}_{l}}$$

is expanded as follow

$$\frac{{ds}_{k}^{t}}{d {θ}_{l}} = \frac{\partial {s}_{k}^{t}}{\partial {θ}_{l}} + \frac{\partial {s}_{k}^{t}}{\partial {y}_{k}^{t - 1}} \frac{{dy}_{k}^{t - 1}}{d {θ}_{l}} + \frac{\partial {s}_{k}^{t}}{\partial {y}_{k - 1}^{t}} \frac{{dy}_{k - 1}^{t}}{d {θ}_{l}} . \qquad ( 34 )$$

We define a recursive term

$${χ}_{{l}_{m}}^{t , θ}$$

as

$$χ {i}_{m}^{t , θ} := \frac{{ds}_{l}^{t}}{d {θ}_{m}} = \frac{\partial {s}_{l}^{t}}{\partial {s}_{m}^{t - 1}} χ {l}_{m}^{t - 1 , θ} + \frac{\partial {s}_{l}^{t}}{\partial {y}_{l}^{t - 1}} ( \frac{\partial {y}_{l}^{t - 1}}{\partial {s}_{l}^{t - 1}} {χ}_{{l}_{m}}^{t - 1 , θ} + \frac{\partial {y}_{l}^{t - 1}}{\partial {θ}_{m}} ) + \frac{\partial {s}_{l}^{t}}{\partial {y}_{l - 1}^{t}} ( \frac{\partial {y}_{l - 1}^{t}}{\partial {s}_{l - 1}^{t}} {χ}_{{l - 1}_{m}}^{t , θ} + \frac{\partial {y}_{l - 1}^{t}}{\partial {θ}_{m}} ) + \frac{\partial {s}_{l}^{t}}{\partial {θ}_{m}} , \qquad ( 35 )$$

with the following properties

$$\begin{matrix}{e}_{l}^{t , θ} := {χ}_{{l}_{l}}^{t , θ} & ( 36 ) \\ {e}_{l}^{t , θ} := \frac{{dy}_{l}^{t}}{d {θ}_{l}} = ( \frac{\partial {y}_{l}^{t}}{\partial {s}_{l}^{t}} {χ}_{{l}_{l}}^{t , θ} + \frac{\partial {y}_{l}^{t}}{\partial {θ}_{l}} ) \\ {χ}_{{l}_{m}}^{t < 1 , θ} = 0 \\ {χ}_{{l}_{l + 1}}^{i , θ} = 0 \\ {χ}_{{l < 1}_{m}}^{t , θ} = 0 \\ {χ}_{{l}_{m < 1}}^{t , θ} = 0. & ( 37 )\end{matrix}$$

The term

$${χ}_{{l}_{m}}^{t , θ}$$

for k≠l contains a recursion in time, but additionally it contains a recursion in space, i.e., it depends on other layers, for example the (k−1)-th layer.
If we insert the term

$${χ}_{{l}_{m}}^{t , θ}$$

in Equation 33 we obtain

$$\frac{dE}{d {θ}_{l}} = {\sum }_{1 \leq t \leq T} \frac{\partial {E}^{t}}{\partial {y}_{k}^{t}} [ \frac{\partial {y}_{k}^{t}}{\partial {s}_{k}^{t}} {χ}_{{k}_{l}}^{t , θ} + \frac{\partial {y}_{k}^{l}}{\partial {θ}_{l}} ] . \qquad ( 38 )$$

The right-hand side of Equation 38 is expanded to a more complex expression

$$\frac{dE}{d {θ}_{l}} = {\sum }_{1 \leq t \leq T} [ \frac{{dE}^{t}}{{dy}_{k}^{t}} [ \frac{\partial {y}_{k}^{t}}{\partial {s}_{k}^{t}} \frac{\partial {s}_{k}^{t}}{\partial {s}_{k}^{t - 1}} {χ}_{{k}_{l}}^{t - 1 , θ} + \frac{\partial {y}_{k}^{t}}{\partial {s}_{k}^{t}} \frac{\partial {s}_{k}^{t}}{\partial {y}_{k}^{t - 1}} ( \frac{\partial {y}_{k}^{t - 1}}{\partial {s}_{k}^{t - 1}} {χ}_{{k}_{l}}^{t - 1 , θ} + \frac{\partial {y}_{k}^{t - 1}}{\partial {θ}_{l}} ) + \frac{\partial {y}_{k}^{t}}{\partial {s}_{k}^{t}} \frac{\partial {s}_{k}^{t}}{\partial {y}_{k}^{t - 1}} ( \frac{\partial {y}_{k}^{t - 1}}{\partial {s}_{k}^{t - 1}} {χ}_{{k - 1}_{l}}^{t , θ} + \frac{\partial {y}_{k - 1}^{t}}{\partial {θ}_{l}} ) + \frac{\partial {y}_{k}^{t}}{\partial {s}_{k}^{t}} \frac{\partial {s}_{k}^{t}}{\partial {θ}_{l}} ] + \frac{\partial {y}_{k}^{t}}{\partial {θ}_{l}} ] , \qquad ( 39 )$$

where the two recurrencies—

$${χ}_{{k - 1}_{l}}^{t , θ}$$

in space, and

$${χ}_{{k}_{l}}^{t - 1 , θ}$$

in time—become apparent. When expanding

$${χ}_{{k - 1}_{l}}^{t}$$

far enough in space, it eventually reaches

$${χ}_{{t}_{l}}^{t , θ} = {∈}_{l}^{t} .$$

Therefore, we can rewrite Equation 39 as

$$\frac{dE}{d {θ}_{l}} = {\sum }_{1 \leq t \leq T} [ \frac{d {E}^{t}}{{dy}_{k}^{t}} ( {\prod }_{( k - l + 1 ) \geq {m}^{′} \geq 1} \frac{\partial {y}_{k - {m}^{′} + 1}^{t}}{\partial {s}_{k - {m}^{′} + 1}^{t}} \frac{\partial {s}_{k - {m}^{′} + 1}^{t}}{\partial {y}_{k - {m}^{′} + 1}^{t}} ) ( \frac{\partial {y}_{l}^{t}}{\partial {s}_{l}^{t}} {χ}_{{l}_{l}}^{t , θ} + \frac{\partial {y}_{k}^{l}}{\partial {θ}_{l}} ) + R ] , \qquad ( 40 )$$

where we collect all the remaining terms into a residual term R. In addition, we define a generalized learning signal Lₗ^{t} and a generalized eligibility trace eₗ^{t,θ} as

$$\begin{matrix}{L}_{l}^{t} = \frac{\partial {E}^{t}}{\partial {y}_{k}^{t}} ( {\prod }_{( k - l + 1 ) \geq {m}^{′} \geq 1} \frac{\partial {y}_{k - {m}^{′} + 1}^{t}}{\partial {s}_{k - {m}^{′} + 1}^{t}} \frac{\partial {s}_{k - {m}^{′} + 1}^{t}}{\partial {y}_{k - {m}^{′}}^{t}} ) & ( 41 ) \\ {e}_{l}^{t , θ} = ( \frac{\partial {y}_{l}^{t}}{\partial {s}_{l}^{t}} {ϵ}_{l}^{t , θ} + \frac{\partial {y}_{l}^{t}}{\partial {θ}_{l}} ) . & ( 42 )\end{matrix}$$

see Equations 10-11. This allows to express the parameter update as

$$\frac{dE}{d {θ}_{l}} = {\sum }_{1 \leq t \leq T} [ {L}_{l}^{t} {e}_{l}^{t , θ} + R ] , \qquad ( 43 )$$

see Equation 13. By omitting the residual term R according to embodiments, we arrive at Equation 14.

What is claimed is:

1. A computer-implemented method for training a neural network, the network comprising one or more layers of neuronal units, wherein each neuronal unit has an internal state, wherein the method comprises:
providing training data comprising an input signal and an expected output signal to the neural network;
computing, for each neuronal unit, a spatial gradient component;
computing, for each neuronal unit, a temporal gradient component; and
updating the temporal and the spatial gradient component for each neuronal unit at each time instance of the input signal.

2. The computer-implemented method according to claim 1, wherein the computing of the spatial and the gradient component is performed independently from each other.

3. The computer-implemented method according to claim 1, further comprising updating a predefined set of training parameters of the neural network as a function of the spatial and the temporal gradient component.

4. The computer-implemented method according to claim 3, further comprising updating the predefined set of training parameters of the neural network at specific or predefined time instances as a function of the spatial and the temporal gradient components.

5. The computer-implemented method according to claim 4, further comprising updating the predefined set of training parameters of the neural network at each time instance as a function of the spatial and the temporal gradient components.

6. The computer-implemented method according to claim 1, wherein the method comprises:
computing, at each time instance, a spatial gradient component for each of the one or more layers; and
computing, at each time instance, a temporal gradient component for each of the one or more layers.

7. The computer-implemented method according to claim 1, wherein:
the spatial gradient component is based on connectivity parameters of the neural network; and
the temporal gradient component is based on parameters related to temporal dynamics of the neuronal units.

8. The computer-implemented method according to claim 1, wherein the network comprises a single layer of neuronal units and computing the spatial gradient component comprises computing:
$${L}^{t} : = \frac{\partial {E}^{t}}{\partial {y}^{t}}$$
wherein
t denotes the respective time instance;
L^{t} denotes the spatial gradient component at time instance t;
E^{t} denotes the network error, in particular the error between an expected output signal and the current output signal at time instance t;
and
y^{t} denotes the current output signal at time instance t.

9. The computer-implemented method according to claim 1, further comprising updating a predefined set of training parameters of the neural network as a function of the spatial and the temporal gradient component, wherein the network comprises a single layer of neuronal units and computing the temporal gradient component comprises computing:
$${e}^{t , θ} : = \frac{d {y}^{t}}{d θ} = \frac{\partial {y}^{t}}{\partial {s}^{t}} {ϵ}^{t , θ} + \frac{\partial {y}^{t}}{\partial θ}$$
$${ϵ}^{t , θ} : = \frac{d {s}^{t}}{d θ} = ( \frac{d {s}^{t}}{d {s}^{t - 1}} {ϵ}^{t - 1 , θ} + ( \frac{\partial {s}^{t}}{\partial θ} + \frac{\partial {s}^{t}}{\partial {y}^{t - 1}} \frac{\partial {y}^{t - 1}}{\partial θ} ) )$$
wherein
t denotes the respective time instance;
y^{t} denotes the current output signal at time instance t;
s^{t} denotes the unit state at time instance t;
θ denotes the training parameters of the network; and
$${ϵ}^{t , θ} : = \frac{d {s}^{t}}{d θ} .$$

10. The computer-implemented method according to claim 9, wherein updating the training parameters comprises computing;
$$Δ θ = α {\sum }_{t} {L}^{t} {e}^{t , θ} ,$$
wherein α is a learning rate.

11. The computer-implemented method according to claim 1, wherein the network comprises a plurality of layers of neuronal units and computing the spatial gradient component comprises computing:
$${L}_{l}^{t} = \frac{\partial {E}^{t}}{\partial {y}_{k}^{t}} ( {\prod }_{( k - l + 1 ) \geq {m}^{′} \geq 1} \frac{\partial {y}_{k - {m}^{′} + 1}^{t}}{\partial {s}_{k - {m}^{′} + 1}^{t}} \frac{\partial {s}_{k - {m}^{′} + 1}^{t}}{\partial {y}_{k - {m}^{′}}^{t}} )$$
wherein:
Lₗ^{t} denotes the spatial gradient component of layer l at time instance t;
E^{t} denotes a network error, in particular the error between an expected output signal and the current output signal at time instance t;
t denotes the respective time instance;
yₖ^{t} denotes the current output signal of layer k;
sₖ^{t} denotes the unit state of layer k;
k denotes the last layer/output layer of the network; and
m′ denotes intermediate layers of the network ranging from 1 to (k−l+1)

12. The computer-implemented method according to claim 1, wherein the network comprises a plurality of layers of neuronal units and computing the temporal gradient component comprises computing:
$${e}_{l}^{t , θ} = ( \frac{\partial {y}_{l}^{t}}{\partial {s}_{l}^{t}} {ϵ}_{l}^{t , θ} + \frac{\partial {y}_{l}^{t}}{\partial {θ}_{l}} )$$
$${ϵ}_{l}^{t , θ} = ( \frac{d {s}_{l}^{t}}{d {s}_{l}^{t - 1}} {ϵ}_{l}^{t - 1 , θ} + ( \frac{\partial {s}_{l}^{t}}{\partial {θ}_{l}} + \frac{\partial {s}_{l}^{t}}{\partial {y}_{i}^{t - 1}} \frac{\partial {y}_{l}^{t - 1}}{\partial {θ}_{l}} ) )$$
wherein
t denotes the respective time instance;
l denotes the respective layer;
y^{t} denotes the current output signal;
s^{t} denotes the current unit state;
θ denotes training parameters of the network; and
$${ϵ}^{t , θ} : = \frac{d {s}^{t}}{d θ} .$$

13. The computer-implemented method according to claim 1, further comprising updating a predefined set of training parameters of the neural network as a function of the spatial and the temporal gradient component, wherein updating the training parameters comprises computing:
$$\frac{dE}{d {θ}_{l}} = {\sum }_{t} [ {L}_{l}^{t} {e}_{l}^{t , θ} + R ]$$
wherein R is a residual term.

14. The computer-implemented method according to claim 13, wherein the residual term R is approximated with a combination of eligibility traces and learning signals.

15. The computer-implemented method according to claim 1, further comprising updating a predefined set of training parameters of the neural network as a function of the spatial and the temporal gradient component, wherein updating the network parameters comprises computing:
$$Δ {θ}_{l} = α {\sum }_{t} {L}_{l}^{t} {e}_{l}^{t , θ} ,$$
wherein α is a learning rate.

16. The computer-implemented method according to claim 1, wherein the neural network is selected from the group consisting of: a recurrent neural network, a hybrid network, a spiking neural network and a generic recurrent network, the generic recurrent network in particular comprising or consisting of long-short-term-memory units and gated recurrent units.

17. The computer-implemented method according to claim 1, further comprising updating a predefined set of training parameters of the neural network as a function of the spatial and the temporal gradient component, wherein the network comprises a plurality of layers of neuronal units and computing the temporal gradient component comprises computing:
$${Δθ}_{l} = α {\sum }_{t} {L}_{l}^{t} {e}_{l}^{t , θ} ,$$
wherein:
t denotes the respective time instance;
l denotes the layer;
y^{t} denotes the current output signal;
s^{t} denotes the current unit state;
θ denotes the trainable parameters of the network; and
$${ϵ}^{t , θ} := \frac{{ds}^{t}}{d θ} .$$

18. A neural network comprising one or more layers of neuronal units, wherein each neuronal unit has an internal state, wherein the neural network is configured to perform a method for training a neural network, the method comprising
providing training data comprising an input signal and an expected output signal to the neural network;
computing, for each neuronal unit, a spatial gradient component;
computing, for each neuronal unit, a temporal gradient component; and
updating the temporal and the spatial gradient component for each neuronal unit at each time instance of the input signal.

19. The neural network according to claim 18, wherein the neural network is further configured to update parameters of the neural network at each time instance as a function of the spatial and the temporal gradient components.

20. A computer program product for training a recurrent neural network, the computer program product comprising a computer readable storage medium having program instructions embodied therewith, the program instructions executable by the neural network to cause the neural network to perform a method comprising:
receiving training data comprising an input signal and an expected output signal;
computing, for each neuronal unit, a spatial gradient component;
computing, for each neuronal unit, a temporal gradient component; and
updating the temporal and the spatial gradient component for each neuronal unit at each time instance of the input signal.

21. The computer program product according to claim 20, the program instructions executable by the neural network to cause the neural network to update parameters of the neural network at each time instance as a function of the spatial and the temporal gradient components.

22. A computing system configured to perform a computer-implemented method for training parameters of a neural network, the network comprising one or more layers of neuronal units, wherein each neuronal unit has an internal state, wherein the method comprises:
providing training data comprising an input signal and an expected output signal to the neural network;
computing, for each neuronal unit, a spatial gradient component;
computing, for each neuronal unit, a temporal gradient component; and
updating the temporal and the spatial gradient component for each neuronal unit at each time instance of the input signal.

23. The computing system according to claim 22, the computing system comprising a memristive memory array.
